(19) United States
(12) Patent Application Publication
(10) Pub. No.: US 2015/0127216 A1
(43) Pub. Date: May 7, 2015

(54) Electronic interface control system

(71) Applicants: Clinton L. Jackson, SR., St. Louis, MO (US); Theodore Boerding, St. Charles, MO (US)

(72) Inventors: Clinton L. Jackson, SR., St. Louis, MO (US); Theodore Boerding, St. Charles, MO (US)

(73) Assignees: Clington Jackson, SR., St. Charles, MO (US); Theodore Boerding, St. Charles, MO (US)

(21) Appl. No.: 14/483,143

(22) Filed: Sep. 10, 2014

Related U.S. Application Data
(60) Provisional application No. 61/960,104, filed on Sep. 10, 2013.

(51) Int. Cl. B60S 9/10

(52) U.S. Cl. CPC B60S 9/10
USPC 701/36

(57) ABSTRACT

An electronic interface control system with indicators and switching controls being adapted to be disposed efficiently in a vehicle in communication with a pneumatic vehicle safety lift system to conveniently lift a vehicle aground to repair and/or change a tire. Further, a carrying case namely encasing a; safety strut with a means for a locking mechanism and cordless electric lug wrench torque gun to remove lug nuts.

### BACKGROUND

There's prior art of vehicle jacking lift systems in reference to pneumatic, hydraulic and electric systems that do not provide the novelty of the ergonomic consideration, clear operator interface communication by use of indicators, vehicle on board systems and electronic controls that the present invention provides.

### BRIEF SUMMARY OF THE INVENTION

A. Objects of the Invention

One objective of the present invention is to provide a novel electronic interface control system that utilizes light emitting diodes, indicators and a audible vehicle cabin alert to provide a clear process of communication to operate said pneumatic vehicle safety lift system that is herein described.

Second objective of the present invention is to provide improved safety while a vehicle is suspended on a pneumatic vehicle safety lift system.

Third objective of the present invention is to provide an electronic interface control system for a pneumatic vehicle safety lift system integrated in a vehicle that safely and conveniently lift a vehicle aground to repair and/or change a tire.

In view of the above, it is the principal object of this invention to provide a simplified yet improved electronic interface control system for a pneumatic vehicle safety lift system through ergonomic consideration, clear operator interface communication by use of indicators, switching controls and cost effective design/product life cycle management. There are other objectives which are provided as function of the features with the system. These additional functions have not been enumerated in this section but are laid out below.

### BRIEF DESCRIPTION OF THE DRAWINGS

FIG. 1 shows a detailed exploded view of an electronic interface control system whereby an enclosure houses hardware and is composed from a selected group consisting of: metals and polymers.

FIG. 2 represents said electronic interface control system by diagram in concert with a pneumatic vehicle safety lift system.

FIG. 3 displays a carrying case in exploded view encasing namely a; safety strut with a mechanical locking mechanism and a cordless electric torque wrench gun.

FIG. 4 demonstrates a pneumatic jack cylinder assembly of a pneumatic vehicle safety lift system in cutaway view in a vehicle with a pneumatic jack cylinder mounted and disposed in the pillar and dogleg of a vehicle to safely and conveniently lift a vehicle aground for changing a tire and/or repair.

FIG. 5 illustrates an exploded view of a cylinder assembly of a pneumatic vehicle safety lift system namely a; plurality of pneumatic jack cylinders, safety strut with a mechanical locking mechanism, safety strut platform, plurality of threaded mounting cylinder caps and mechanical fasteners, at least one ball bearing in close tolerance or mechanical fastener to the end of a pneumatic jack cylinder piston rod for orbital range of motion of a footplate to adapt to different terrain for the purpose of safely and conveniently lifting a vehicle aground to repair and/or change a tire.

### DETAILED DESCRIPTION AND BEST MODE OF IMPLEMENTATION

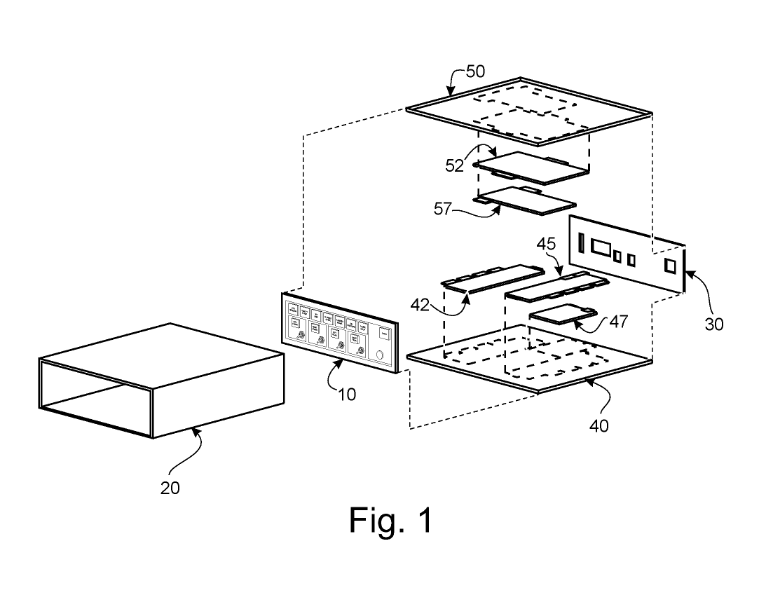

With reference now to the drawings, and in particular to FIGS. 1 through 5 thereof, an electronic interface control system constituting a means for: electronic hardware 42, 45,47,52 and 57, wherein there's an input board 42 to provide reading inputs, an output board 45 to provide operating outputs based on the program control board 47 wherein said program control board 47 has a sequence of operation of a control for a general purpose of said program control board 47 of known type to enable said program control board 47 to execute formulas in an object program comprising a plurality of formulas, such that the same results will be produced when using the same given data, regardless of the sequence in which said formulas are presented in said object program comprising the sequence of commands,
a. examining each of said formulas in a storage area of said program control board 47 to determine which formulas can be designated as defined,
b. storing, in the sequence in which each formula is designated as defined, and
c. repeating all of said sequence of said commands for at least undefined formulas as many times as required until all said formulas have been designated as defined and have been stored; thereby producing the same results upon sequential execution of said formulas stored by said sequence of operation of a control when using the same given data, regardless of the order in which said formulas were presented in said object program prior to said sequence of operation of a control.

A driver board 57 delivers power to drive the system components and a 12v to 5v voltage converter board 52 which converts a 12v power source to a ready 5v output to the driver board 57. There's an object program embedded in the program control board 47 constituting a means for providing the logical results required in reaction to the input states read from a vehicle.

Dynamic memory is also stored in the program control board 47 to hold the results of intermediate decisions based on operating rules, static memory to retain parameters and operating programming when power is removed or the system is restored before installation. Said electronic interface control panel 10 has indicators selected from a group consisting of: lug wrench 22, safety strut 24, excessive tilt 26, flashers 28, parking brake 29, air pressure 31 and trunk open 125, also switching controls left front 33, right front 34, left rear 37, and right rear 38 which control said pneumatic jack cylinders 12 in each quadrant of a vehicle to make it safe to operate a pneumatic vehicle safety lift system. Said electronic interface control system electronic hardware 42, 45, 47, 52 and 57 is enclosed with a housing 20 composed of a group selected from: metal and polymers. There's a backing plate 30, a bottom mounting plate 40 and a top mounting plate 50 to complete said hardware 42,45,47,52 and 57 enclosure.

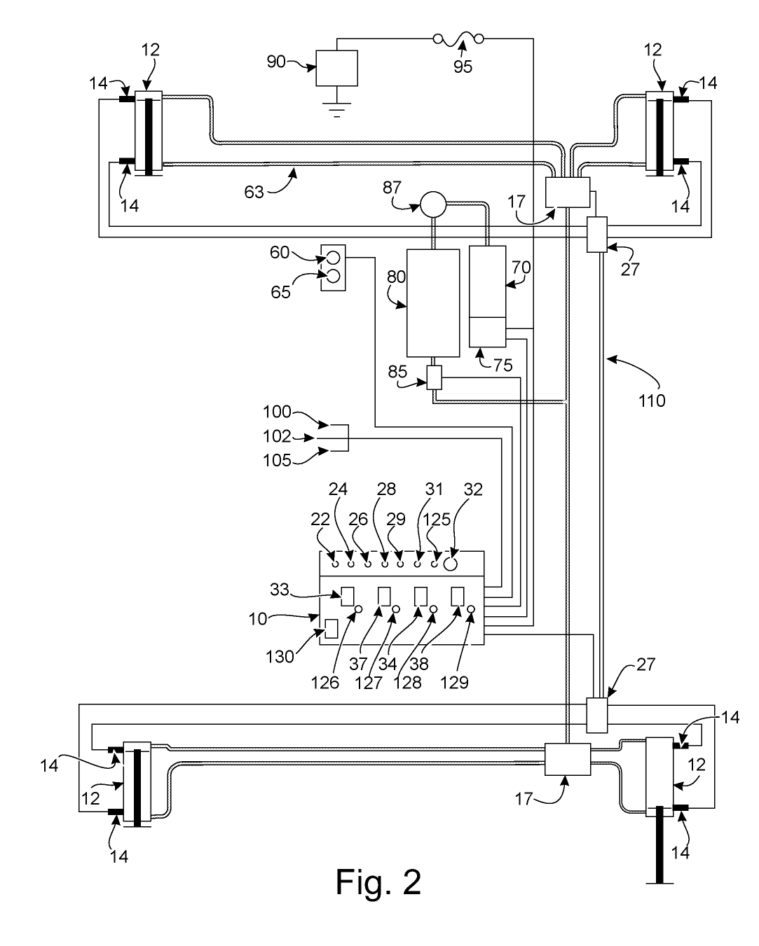

FIG. 2. represents said electronic interface control system by diagram in concert with said pneumatic vehicle safety lift system comprising a: plurality of pneumatic jack cylinders 12 disposed in a vehicle to lift aground, plurality of proximity switches 14 to sense piston stroke position, air valve assembly 17 selected from a group consisting of a: air distribution manifold, plurality of solenoids or at least one check valve to regulate air flow in one direction, at least one air restrictor to control rate of air flow and are disposed in a vehicle. Junction boxes 27 are present for convenient wire 110 connections and are disposed in a vehicle, an audible alert 60 is present to warn the operator and disposed in a vehicle along with a cabin indicator 65 to provide a visual warning to the operator whereby a tri-color light emitting diode indicator is present and disposed in a vehicle, at least one air compressor 70 to produce air, air hose 63 to carry air pressure, compressor relay 75 to control electrical current flow, air reservoir 80 to store ready air pressure, pressure switch 85 to gauge said pneumatic vehicle safety lift system air pressure, air dryer 87 to control humidity, vehicle battery 90 as a power source with a battery return from input and output devices as separate wire 110 conductors with a single point attachment to a vehicle for electrical noise considerations.

All electrical components are grounded in which at least one fuse 95 is provided to protect wires 110 and components in the event of a failure or accidental damage causing an excess of current flow which could cause fire. The fuse 95 size and wire 110 is selected to carry expected current flow safely. A parking brake interlock switch 100 as other input, hazard flashers 102 as other input, trunk open 105 as other input; other inputs are conditions that create a safe sequence of operation according to said object program, said electronic interface control system has a electronic interface control panel 10 with indicators 22, 24,26,28,29, 31 and 58 selected from a group consisting of: lug wrench 22, safety strut 24, excessive tilt 26, flashers 28, parking brake 29, air pressure 31, trunk open 125 and a system start indicator 32. There a four switches to control a plurality of pneumatic jack cylinders that list as: left front 33, right front 37, left rear 34, right rear 38 and system start switch 130. Further, there's four wheel quadrant indicators that list as: left front indicator 126, right front indicator 127, left rear indicator 128 and a right rear indicator 129.

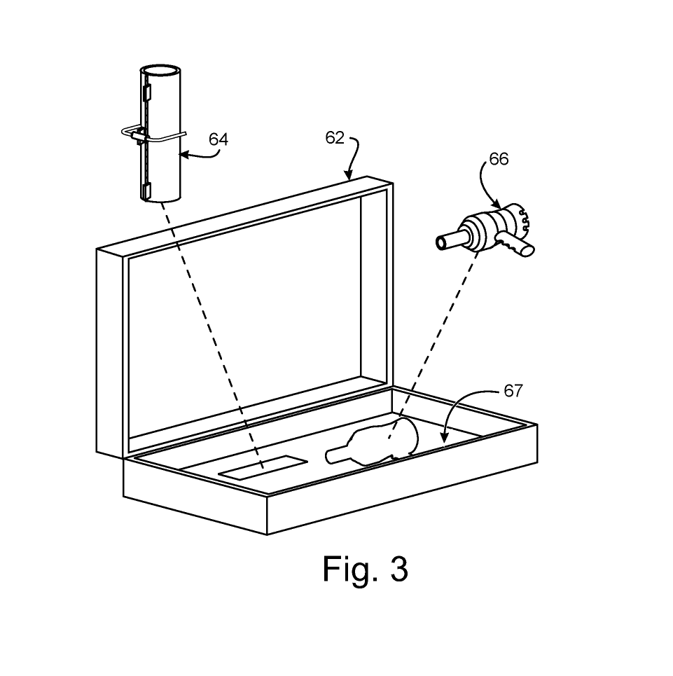

FIG. 3. displays a carrying case 62 in exploded view encasing namely a; safety strut 64 with a mechanical locking mechanism 53, at least one hinge 54, electric lug wrench torque gun 66 which is for removing lug nuts and a foam inset 67 which cradles said safety strut 64 and said electric lug wrench torque gun 66. Switches are present in said carrying case 62 by way of electronic interface control system to indicate said safety strut 64 and said electric lug wrench torque gun 66.

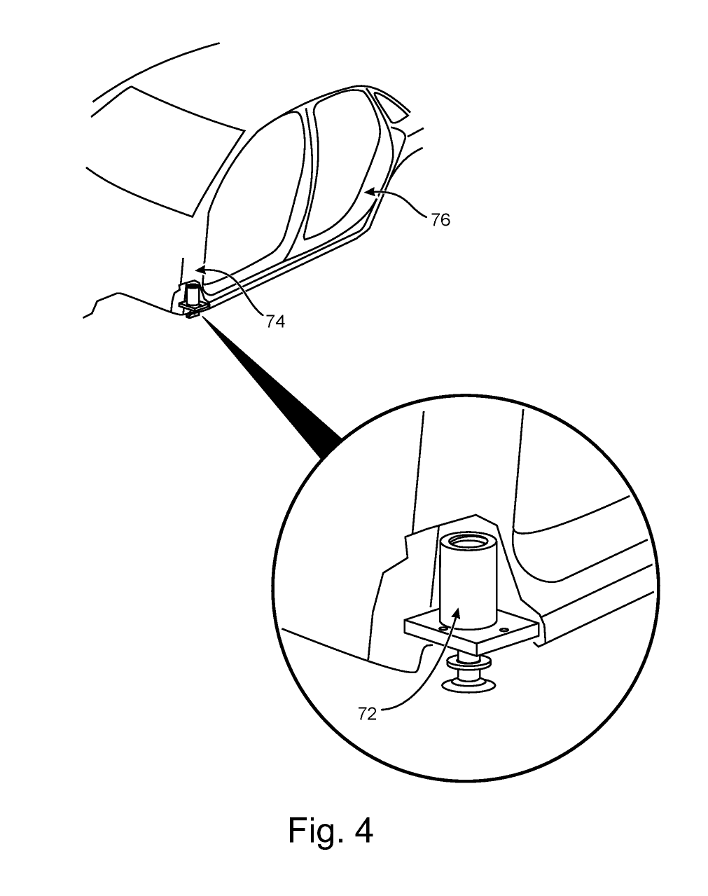

FIG. 4. demonstrates a cylinder assembly 72 in cutaway view in a vehicle with a pneumatic jack cylinder mounted and disposed in the pillar 74 and dogleg 76 of a vehicle to safely and conveniently lift a vehicle aground for changing a tire and/or repair.

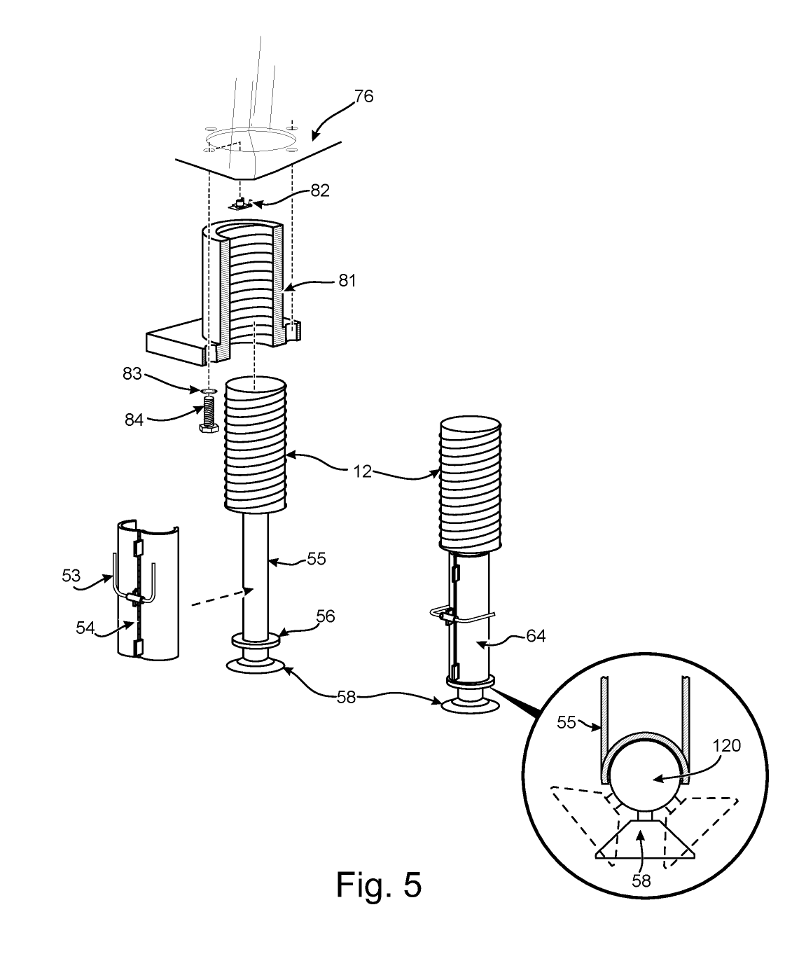

FIG. 5. illustrates a cylinder assembly 72 in exploded view of a pneumatic vehicle safety lift system namely a; plurality of pneumatic jack cylinders 12, cylinder pistons are magnetic to allow detecting stroke positions by magnetically activated sensors, also, said pneumatic jack cylinder 12 piston rods 55 has at least one ball bearing 120 in close tolerance fit or mechanical fasteners to the end of shaft for orbital range of motion for a footplate 58, safety strut 64 with at least one hinge 54, a mechanical locking mechanism 53 for preventing pneumatic jack cylinder 12 failures, said safety strut has a platform 56 to position the safety strut, said safety strut 64 is incandescent or illuminated by mechanical means, plurality of threaded mounting cylinder caps 81 and mechanical fasteners by way of Tinnerman nut 82, washer 83 and bolt 84 for the purpose of safely and conveniently lifting a vehicle aground to repair and/or change a tire. Said pneumatic jack cylinders 12 are disposed and mounted efficiently in a vehicle selected from a group consisting of a: chassis, vehicle body or unibody by way of mechanical fasteners, close tolerance fit and from a selected group consisting of a: weld, brazed bond and bonding; said pneumatic jack cylinders 12 are composed from a selected group consisting of aluminum, tungsten, composite polymers, polymers, carbon fiber, and steel.

While the above detailed description has shown, described and pointed out the fundamental novel features of the invention as applied to various embodiments, it is understood that various substitutions and changes in the form and details of the electronic interface control system as illustrated, may be made by those skilled in the art, without departing from the spirit of the invention.

1. An electronic interface control system with an audible alert and cabin indicator disposed in a vehicle, said electronic interface control system comprising a safety strut indicator, trunk open indicator, excessive tilt indicator, parking brake indicator, flasher indicator and a cordless electric lug wrench torque gun indicator operated by way of electronic hardware and software including, a general purpose program control board of known type to enable said program control board to execute formulas in an object program comprising a plurality of formulas, such that the same results will be produced when using the same given data, regardless of the sequence in which said formulas are presented in said object program comprising the sequence of said commands,
a. examining each of said formulas in a storage area of said program control board to determine which formulas can be designated as defined,
b. storing, in the sequence in which each formula is designated as defined, and
c. repeating all of said sequence of commands for at least undefined formulas as many times as required until all said formulas have been designated as defined and have been stored; thereby producing the same results upon sequential execution of said formulas stored by said sequence of operation of a control when using the same given data, regardless of the order in which said formulas were presented in said object program prior to said sequence of operations of a control,
1) a left front switch, right front switch, left rear switch and a right rear switch and a system start switch to initiate a plurality of pneumatic jack cylinders that are composed from a selected group consisting of aluminum, tungsten, composite polymers, polymers, carbon fiber and steel, further there's four wheel quadrant indicators to indicate the wheel in use.
2) a carrying case housing a safety strut and a cordless electric lug wrench torque gun wherein said safety strut has at least one hinge, a mechanical locking mechanism to prevent inadvertent pneumatic jack cylinder failures and a safety strut platform that positions said safety strut in place, said cordless electric lug wrench torque gun is indicated by said electronic interface control system connected to a vehicles battery or auxiliary power source, said safety strut is incandescent or illuminated by mechanical means for safety purposes.

2. The electronic interface control system according to claim 1, wherein said electronic interface control system controls a pneumatic vehicle safety lift system by way of parking brake interlock switch as other input, hazard flashers as other input, trunk open as other input; other inputs are conditions that create a safe sequence of operation according to said object program, plurality of pneumatic jack cylinders, at least one magnetic proximity switch to monitor piston stroke, at least one air compressor that provides air pressure, air hose to carry air pressure, wire and electrical connections to deliver electricity to components, at least one fuse to control excessive current flow, at least one air pressure switch that monitors air pressure, at least one air dryer to remove humidity from the compressed air, an air reservoir to hold a volume of air under pressure to pressurize a pneumatic jack cylinder, air control valve assemblies are selected from a group consisting of a: air distribution manifold, plurality of solenoids, at least one check valve, at least one air restrictor, said air control valve assemblies are disposed in the front and rear of a vehicle for pneumatic hose routing convenience, safety strut with at least one hinge, a safety strut locking mechanism that locks by mechanical means which prevents said jack cylinder from inadvertently retracting, at least one cordless electric lug wrench torque gun whereby controls said pneumatic vehicle safety lift system.

3. The electronic interface control system according to claim 2, wherein said pneumatic vehicle safety lift system jack cylinders are mounted and disposed in the pillar and dogleg from a selected group consisting of a: vehicle chassis, vehicle body or unibody by way of mechanical fasteners, close tolerance fit and from a selected group consisting of a: weld, brazed bond, and bonding.

4. The electronic interface control system according to claim 1, wherein said pneumatic jack cylinders are composed from a selected group consisting of: aluminum, tungsten, composite polymers, polymers, carbon fiber and steel.

5. The electronic interface control system according to claim 4, wherein said pneumatic jack cylinders having piston rods with at least one ball bearing in close tolerance fit or mechanical fastener to the end of said pneumatic jack cylinder piston rod for orbital range of motion for a foot plate.
